(19) United States
(12) Patent Application Publication
(10) Pub. No.: US 2003/0000756 A1
(43) Pub. Date: Jan. 2, 2003

(54) Apparatus for detecting brake oil level and controlling engine operation

(76) Inventor: Lo Chin-Chun, Taipei (TW)

Correspondence Address: BACON & THOMAS, PLLC, 625 SLATERS LANE, FOURTH FLOOR, ALEXANDRIA, VA, 22314

(21) Appl. No.: 09/894,001

(22) Filed: Jun. 29, 2001

(51) Int. Cl. B60L 3/00; B60K 28/00

(52) U.S. Cl. 180/271; 188/1.11 E

(57) ABSTRACT

An apparatus for detecting brake oil level and controlling engine operation includes a detecting wiring inside a brake oil cup for detecting an oil level of a brake oil. The oil level inside the oil cup floats a buoyant plate with a plurality of holes for stabilizing the oil level to preventing from any detecting error of the oil level. The detecting wiring is mounted to a triangular pillar. The triangular pillar provides three lateral sides to adhere respectively three conductive components of the detecting wiring with different lengths. A control circuitry is also included to detect the oil level and to determine the alarm light selected from a green light, a yellow light and a red light, in which the yellow light can be flickered for a particular alarming purpose.

### BACKGROUND OF THE INVENTION

(1) Field of the Invention

The invention relates to an apparatus for detecting a brake oil level and for controlling engine operation, and more particularly applied to a brake oil cup which includes a porous buoyant plate for stabilizing the oil level, a trident detecting wiring for providing accurate detecting signals, and a detecting circuitry having a yellow flicker light for particularly alarming.

(2) Description of the Prior Art

In both U.S. Pat. Nos. 5,501,294 and 5,785,142, the applicant same as the one for the present invention introduces a brake oil lever safety device for motor. Either of above patents mainly discloses a teaching to construct a detecting wiring in the brake oil cup for detecting the level of the brake oil. By providing the detecting wiring, a control circuitry can issue a green light, a yellow light or a red light to attract the driver's attention upon the level of the brake oil. Once the level in the oil cup is below a safety lower limit, the control circuitry can interrupt the ignition system for stopping the operation of the engine. Thereby, dysfunction of the braking system caused by deficiency of brake oil while in engine rung can thus be avoided.

Nevertheless, at least three practical shortcomings of said patents, as follows, exist.

1. A fault oil level might be detected in the case that the oil inside the oil cup waves violently while the vehicle is driven.

2. The reliability of the detecting signals is doubt because three wires of the detecting wiring are separately mounted inside the oil cup and also the oil level fluctuates all the time.

3. The yellow light of the detecting circuitry for symbolizing an urgent requirement of oil refilling or inspection is not so eye-catching to meet its particular purpose.

### SUMMARY OF THE INVENTION

Accordingly, it is a primary object of the present invention to provide an apparatus for detecting brake oil level and controlling engine operation.

To resolve the waving problem in the oil cup, the apparatus in accordance with the present invention provides a buoyant plate to the oil level of the brake oil cup. The buoyant plate includes a plurality of holes for reducing the waving inside the oil cup, so that the oil level can be kept more stably and thus the oil level can be detected more accurately. In addition, to resolve the problem caused by the mounting of those three detecting wires, the present invention integrates those three wires onto a triangular pillar.

The triangular pillar, made of an insulating material, provides three lateral sides to adhere respective conductive components. Thereby, the sensing area of the detecting circuitry can be shrunk and a more accurate oil level can be detected. Furthermore, the detecting circuitry is improved to have the yellow light flickered.

All these objects are achieved by the apparatus for detecting brake oil level and controlling engine operation described below.

### BRIEF DESCRIPTION OF THE DRAWINGS

The present invention will now be specified with reference to its preferred embodiment illustrated in the drawings, in which

FIG. 1A is a top view of a preferred embodiment of a buoyant plate in accordance with the present invention;

FIG. 1B is a schematic view showing a state of the buoyant plate of FIG. 1A applied in a brake oil cup;

FIG. 2A is a perspective view of a preferred embodiment of a detecting wiring in accordance with the present invention;

FIG. 2B is a schematic view showing a state of the detecting wiring of FIG. 2A applied in the brake oil cup; and

FIG. 3 shows a preferred embodiment of a detecting circuitry of the brake oil level in accordance with the present invention.

### DESCRIPTION OF THE PREFERRED EMBODIMENT

The invention disclosed herein is directed to an apparatus for detecting brake oil level and controlling engine operation. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

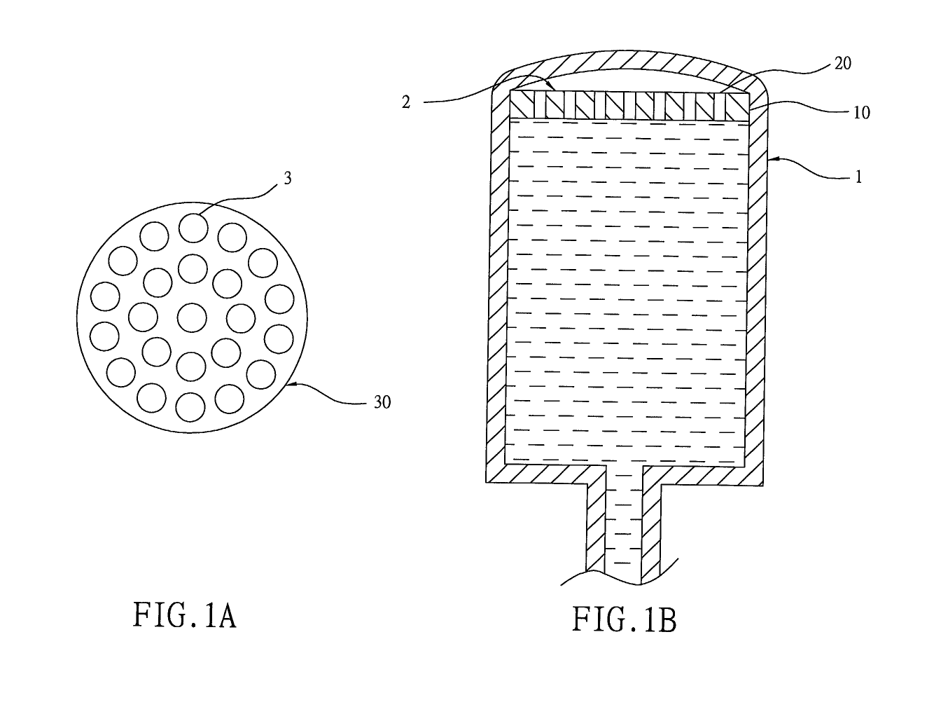

Referring now to FIG. 1A and FIG. 1B, a buoyant plate 2 of the present invention is included to be floated inside an oil cup 1. The buoyant plate 2 as shown has a plurality of holes 20. While the oil surface 10 inside the oil cup 1 waves along with the shaking of driving a vehicle, the turbulent wave can be substantially diminished by acting with those holes 20 of the buoyant plate 2. By providing the buoyant plate 2 floating stably upon the oil, the variation of the oil level due to any forcing can be reduced to a substantial degree.

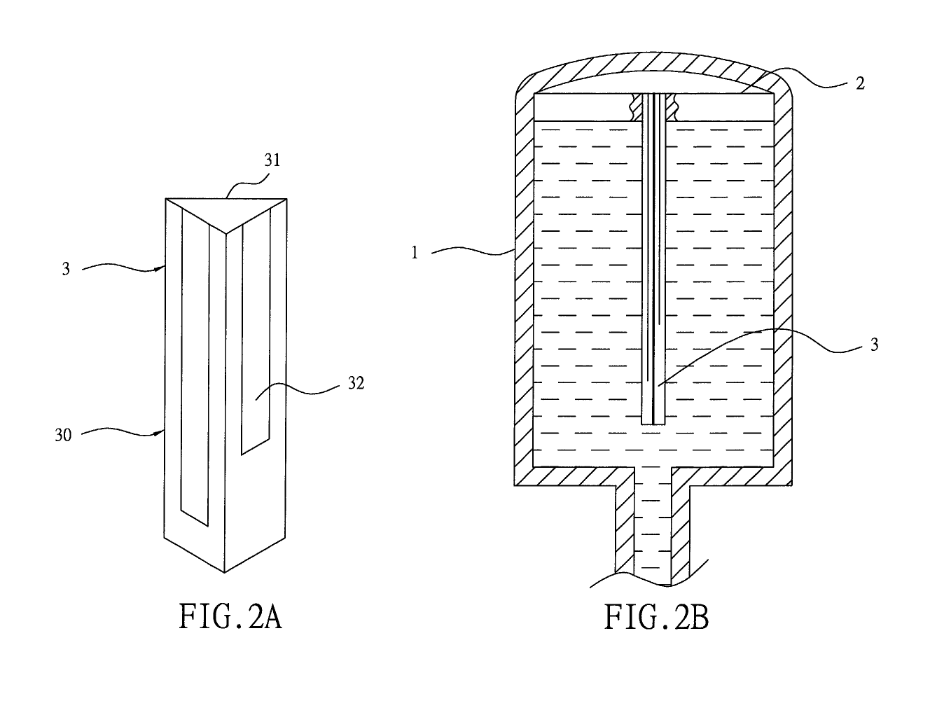

Referring now to FIG. 2A and FIG. 2B, the detecting wiring 3 of the oil level is shown to be constructed at a triangular pillar 30. The pillar 30 can be made of a corrosion-proof insulating material as the glass for example. The triangular pillar 30 provides three lateral sides 31 for adhering respective conductive components 32 with different lengths. The conductive components 32 can be made of an aluminum foil, a cupper foil, a silver foil or any material the like. The detecting wiring 3 of the oil level can be installed at a proper place inside the oil cup 1. As shown in FIG. 2B, the detecting wiring 3 is mounted close to a wall 11 of the oil cup 1, preferably to be mounted at a center of the oil cup 1. Upon such an arrangement, the sensing area of the detecting wiring 3 can be limited to a small stable area and thus a more accurate oil level can be provided by the conductive components 32.

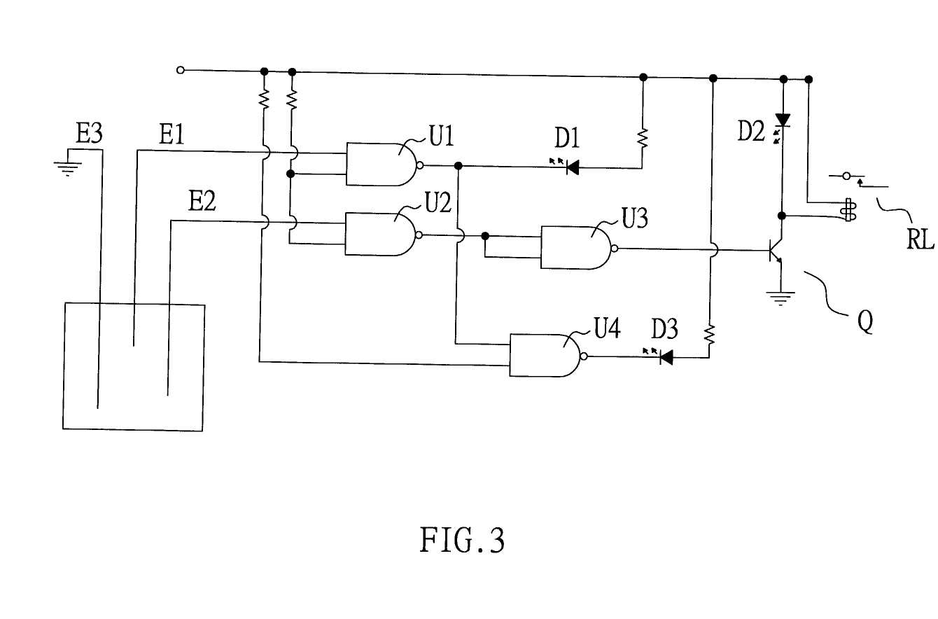

Referring now to FIG. 3, a preferred embodiment of a detecting circuitry of the brake oil level is shown. As shown, E1 and E2 are an upper and a lower conductive components of the detecting wiring 3, respectively. E3 is a ground component of the detecting wiring 3. The upper conductive component E1 and the lower conductive component E2 are respectively connected to a first gate U1 and a second gate U2. A first illuminating diode D1 is a yellow-light diode connected with an output port of the first gate U1. A second illuminating diode D2 is a red-light diode connected to an output port of a third gate U3 through a transistor Q. In the case that the oil level inside the oil cup 1 is normal, an operational panel can display a green background light. In the case that the oil level is detected between an upper limit provided by E1 and a lower limit provided by E2, the first illuminating diode D1 can be started to emit flickered yellow light. In the case that the oil level is lower than the conductive component E2, the second illuminating diode D2 can be started to emit red light and also the transistor Q and the relay RL will be triggered to disconnect the power of the ignition system.

While the present invention has been particularly shown and described with reference to a preferred embodiment, it will be understood by those skilled in the art that various changes in form and detail may be without departing from the spirit and scope of the present invention.

I claim:

1. An apparatus for detecting brake oil level and controlling engine operation, including a detecting wiring inside a brake oil cup for detecting an oil level of a brake oil inside the brake oil cup, the detected oil level further transmitted to a control circuitry for determining an alarm light selected from a green light, a yellow light and a red light, characterized on that: the oil level floats a buoyant plate with a plurality of holes, the detecting wiring providing three conductive components to be respectively adhered to three lateral sides of a triangular pillar is mounted at a center of the brake oil cup, and the yellow light is flickered.

2. The apparatus for detecting brake oil level and controlling engine operation according to claim 1, wherein said triangular pillar is made of an insulating material.

3. The apparatus for detecting brake oil level and controlling engine operation according to claim 1, wherein said conductive components have different lengths.

4. The apparatus for detecting brake oil level and controlling engine operation according to claim 1, wherein said conductive components are isolated to each other.

5. The apparatus for detecting brake oil level and controlling engine operation according to claim 1, wherein said triangular pillar is made of a glass material and said conductive components are made of a cupper or a silver foil.
